(19) United States
(12) Patent Application Publication
(10) Pub. No.: US 2026/0231971 A1
(43) Pub. Date: Aug. 13, 2026

(54) THERMORESPONSIVE GEL COMPOSITION AND USES THEREOF

(71) Applicant: Firmenich SA, Satigny (CH)

(72) Inventors: Jian ZHANG, Plainsboro, NJ (US); Amanda SCHOBER, Plainsboro, NJ (US); Jingyu FENG, Plainsboro, NJ (US)

(21) Appl. No.: 19/156,376

(22) PCT Filed: Feb. 14, 2024
(86) PCT No.: PCT/EP2024/053761

§ 371 Date: Aug. 13, 2025

Related U.S. Application Data
(60) Provisional application No. 63/445,906, filed on Feb. 15, 2023.
(60) Provisional application No. 63/450,815, filed on Mar. 8, 2023.
(60) Provisional application No. 63/502,246, filed on May 15, 2023.

(30) Foreign Application Priority Data
Mar. 9, 2023 (EP) 23160998.3

(51) Int. Cl. A23D 7/005; A23J 3/14; A23J 3/16; A23J 3/22; A23L 27/00; A23L 29/244; A23L 29/256

(52) U.S. Cl. CPC A23D 7/0053; A23J 3/14; A23J 3/16; A23J 3/227; A23L 27/80; A23L 29/244; A23L 29/256

(57) ABSTRACT

The present disclosure relates generally to gel compositions that deform or melt under certain thermal conditions. Such compositions can be used in a variety of ways but are particularly useful as a means of replicating fats in certain comestible products, such as food and beverage products, or pet food products. In some embodiments, the gel composition is an emulsion, such as an oil-in-water emulsion or a water-in-oil emulsion. In certain embodiments, the gel compositions are designed to melt under typical cooking conditions. In certain aspects, the disclosure provides meat analogue products that include such gel compositions as a fat mimetic or a fat replacement.

### TECHNICAL FIELD

The present disclosure relates generally to gel compositions that deform or melt under certain thermal conditions. Such compositions can be used in a variety of ways but are particularly useful as a means of replicating fats in certain comestible products, such as food and beverage products, or pet food products. In some embodiments, the gel composition is an emulsion, such as an oil-in-water emulsion or a water-in-oil emulsion. In certain embodiments, the gel compositions are designed to melt under typical cooking conditions. In certain aspects, the disclosure provides meat analogue products that include such gel compositions as a fat mimetic or a fat replacement.

### DESCRIPTION OF RELATED ART

The human diet generally includes protein, carbohydrates, and lipids, as well as materials such as water and fiber that do not contribute substantially to caloric intake. Many foods are relatively high in lipids, as lipids tend to impart a desirable mouthfeel and texture to the food. In general, the presence of lipids in foods tends to make those foods seem juicier and more flavorful. But lipids are calorically dense. And many commonly used lipids tend to e associated with undesirable health consequences. For example, consumption of certain saturated fats, such as those found in animal products, tend to contribute to cardiovascular disease. Thus, their consumption tends to increase the risk of heart attack, stroke, and the like. Other lipids, such as omega-6 unsaturated oils, tend to have certain pro-inflammatory effects on the body, and should only be consumed in moderation. Even so, there is a strong consumer demand for foods rich in lipids despite the problems associated with excessive lipid consumption.

In addition, many consumers are beginning to shift towards a plant-based diet. As a result, many foods have begun to incorporate certain plant proteins, such as pea protein or soy protein, in place of proteins sourced from animal products. But these plant proteins often have a chalky or dry mouthfeel in comparison to animal-derived proteins. Therefore, it is often necessary to enhance the perceived juiciness of such products. This often means increasing the lipid content. And while there are ample plant-derived lipids available to carry out this task, they are not universally healthy. For example, as noted above, omega-6 oils, which are commonly derived from plants, tend to have a pro-inflammatory effect on the human body. And plant-derived saturated fats, such as cocoa butter, may not be significantly healthier than comparable animal-derived fats.

Reducing the lipid content is a common strategy for improving the healthiness of certain foods and beverages. But reducing the lipid content alone is often an inadequate strategy because many consumers do not view such lower-fat products as suitable replacements for a comparable product with a higher lipid content. For example, many consumers still prefer to consume whole milk instead of skim milk, even though skim milk may be healthier. In such cases, the development of a healthier alternative having a lower lipid content is of little value because consumers would rather eat higher-lipid foods than alternatives that lack the desired mouthfeel, juiciness, or creaminess.

Therefore, there is a continuing need to develop materials that are lower in lipid content and have the desirable taste and mouthfeel properties that consumers associate with a higher lipid content.

### SUMMARY

The present disclosure relates to the discovery of a gel composition that provides a suitable replacement for lipids in food or beverages, and that has a lower lipid content than a comparable amount of oil or fat.

In a first aspect, the disclosure provides a gel composition comprising: (a) water; (b) a lipid component; and (c) a polysaccharide blend comprising a first polysaccharide and a second polysaccharide. In some embodiments, the first polysaccharide is glucomannan. In some embodiments, the gel composition comprises a non-animal protein, such as an algal protein, a mycoprotein, or a plant protein. In some embodiments, the non-animal protein is a protein that is at least 50% by weight soluble in water, based on the total weight of the non-animal protein, when introduced to water at a 10% by weight concentration at neutral pH and 25° C. In some embodiments, the non-animal protein is a plant protein, such as potato protein isolate. In some embodiments, the gel composition is an emulsion, such as an oil-in-water emulsion. In some embodiments, the lipid component is an oil, such as an oil derived from plant or algal sources. In some embodiments, the second polysaccharide is an anionic polysaccharide, such as a carrageenan. In certain embodiments, the gel composition is thermoresponsive (for example, melts) when heated above a temperature ranging from 30° C. to 160° C. In some embodiments, the gel composition has a peak melting temperature ranging from 40° C. to 120° C.

In a second aspect, the disclosure provides a process for making a gel composition of the first aspect, the process comprising: (a) mixing water and the polysaccharide blend to form a polysaccharide composition; (b) optionally, introducing a non-animal protein to the polysaccharide composition to form a protein-polysaccharide composition; and (c) introducing a lipid to the polysaccharide composition or the protein-polysaccharide composition to form a gel composition. In some embodiments, the gel composition comprises a non-animal protein, such as an algal protein, a mycoprotein, or a plant protein. In some embodiments, the non-animal protein is a protein that is at least 50% by weight soluble in water, based on the total weight of the non-animal protein, when introduced to water at a 10% by weight concentration at neutral pH and 25° C. In some embodiments, the non-animal protein comprises a plant protein, such as potato protein. In some embodiments, the gel composition is an emulsion, such as an oil-in-water emulsion. In some embodiments, the lipid component is an oil, such as an oil derived from plant or algal sources. In some embodiments, the lipid component is an oil, such as an oil derived from plant or algal sources. In some embodiments, the polysaccharide blend comprises a first polysaccharide and a second polysaccharide. In some embodiments, the first polysaccharide is glucomannan. In some embodiments, the second polysaccharide is an anionic polysaccharide, such as a carrageenan.

In a third aspect, the disclosure provides use of a gel composition of the first aspect to reduce the lipid content of a comestible composition. In some embodiments, the comestible composition comprises another non-animal protein, such as a plant protein, for example, pea protein, hemp protein, or soy protein. In some embodiments, the comestible composition comprises one or more flavors or flavor-modifying compounds, such as meat or fish flavorings, iron compounds, and the like. In some embodiments, the comestible composition comprises one or more fibers, such as plant fibers, for example, pea fiber, citrus fiber, and the like. In a related aspect, the disclosure provides a method of reducing a lipid content of a comestible composition, the method comprising introducing a gel composition of the first aspect to the comestible composition.

In a fourth aspect, the disclosure provides use of a gel composition of the first aspect to enhance the perceived fattiness of a comestible composition. In some embodiments, the comestible composition comprises another non-animal protein, such as a plant protein, for example, pea protein, hemp protein, or soy protein. In some embodiments, the comestible composition comprises one or more flavors or flavor-modifying compounds, such as meat or fish flavorings, iron compounds, and the like. In some embodiments, the comestible composition comprises one or more fibers, such as plant fibers, for example, pea fiber, citrus fiber, and the like. In a related aspect, the disclosure provides a method of enhancing the perceived fattiness of a comestible composition, the method comprising introducing a gel composition of the first aspect to the comestible composition.

In a fifth aspect, the disclosure provides use of a gel composition of the first aspect to enhance the perceived juiciness of a comestible composition. In some embodiments, the comestible composition comprises another non-animal protein, such as a plant protein, for example, pea protein, hemp protein, or soy protein. In some embodiments, the comestible composition comprises one or more flavors or flavor-modifying compounds, such as meat or fish flavorings, iron compounds, and the like. In some embodiments, the comestible composition comprises one or more fibers, such as plant fibers, for example, pea fiber, citrus fiber, and the like. In a related aspect, the disclosure provides a method of enhancing the perceived juiciness of a comestible composition, the method comprising introducing a gel composition of the first aspect to the comestible composition.

In a sixth aspect, the disclosure provides use of a gel composition of the first aspect to enhance the perceived creaminess of a comestible composition. In some embodiments, the comestible composition comprises another non-animal protein, such as a plant protein, for example, pea protein, hemp protein, or soy protein. In some embodiments, the comestible composition comprises one or more flavors or flavor-modifying compounds, such as meat or fish flavorings, iron compounds, and the like. In some embodiments, the comestible composition comprises one or more fibers, such as plant fibers, for example, pea fiber, citrus fiber, and the like. In a related aspect, the disclosure provides a method of enhancing the perceived creaminess of a comestible composition, the method comprising introducing a gel composition of the first aspect to the comestible composition.

In a seventh aspect, the disclosure provides use of a gel composition of the first aspect to enhance the mouthfeel of a comestible composition. In some embodiments, the comestible composition comprises another non-animal protein, such as a plant protein, for example, pea protein, hemp protein, or soy protein. In some embodiments, the comestible composition comprises one or more flavors or flavor-modifying compounds, such as meat or fish flavorings, iron compounds, and the like. In some embodiments, the comestible composition comprises one or more fibers, such as plant fibers, for example, pea fiber, citrus fiber, and the like. In a related aspect, the disclosure provides a method of enhancing the mouthfeel of a comestible composition, the method comprising introducing a gel composition of the first aspect to the comestible composition.

In an eighth aspect, the disclosure provides a comestible composition comprising a gel composition of the first aspect. In some embodiments, the comestible composition comprises another non-animal protein, such as a plant protein, for example, pea protein, hemp protein, or soy protein. In some embodiments, the comestible composition comprises one or more flavors or flavor-modifying compounds, such as meat or fish flavorings, iron compounds, and the like. In some embodiments, the comestible composition comprises one or more fibers, such as plant fibers, for example, pea fiber, citrus fiber, and the like.

In a ninth aspect, the disclosure provides a flavored product, which comprises the comestible composition of the eighth aspect. In some embodiments, the flavored product is a food product, such as a meat analogue product or a seafood analogue product, for example, a non-animal-based ground beef replica. In some other embodiments, the flavored product is an animal feed product, such as pet food product. In some embodiments, the flavored product is a food or beverage product, such as a dairy analogue product, for example, a non-animal-based dairy product. In such flavored products, the comestible composition can, in some embodiments, be used in combination with animal-based products to reduce the degree of animal fats or animal products in the comestible product. In other embodiments, the flavored products contain no animal-based products, such that the comestible composition is used to make an analogue or a replica of a meat product, such as a ground beef patty.

Further aspects, and embodiments thereof, are set forth below in the Detailed Description, the Abstract, and the Claims.

### BRIEF DESCRIPTION OF DRAWINGS

The following drawings are provided for purposes of illustrating various embodiments of the compositions and methods disclosed herein. The drawings are provided for illustrative purposes only, and are not intended to describe any preferred compositions or preferred methods, or to serve as a source of any limitations on the scope of the claimed inventions.

FIG. 1 shows the rheological data for a gel composition disclosed herein.

FIG. 2 shows the rheological data for a gel composition disclosed herein.

FIG. 3 shows the rheological data for a gel composition disclosed herein.

FIG. 4 shows the rheological data for a gel composition disclosed herein.

FIG. 5 shows the rheological data for a gel composition disclosed herein.

FIG. 6 shows the rheological data for a gel composition disclosed herein.

FIG. 7 shows the rheological data for a gel composition disclosed herein.

FIG. 8 shows the rheological data for a gel composition disclosed herein.

FIG. 9 shows the gel melting curve for a gel composition disclosed herein.

FIG. 10 shows the gel melting curve for a gel composition disclosed herein.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A is present and not B, that B is present and not A, or that A and B are both present. Further, if A, for example, defines a class that can have multiple members, e.g., A₁ and A₂, then one or more members of the class can be present concurrently.

Unless specified otherwise, numerical ranges expressed in the format “from x to y” are understood to include x and y. When for a specific feature multiple preferred ranges are described in the format “from x to y”, it is understood that all ranges combining the different endpoints are also contemplated.

Unless specified otherwise, all percentages refer to percent by weight, based on the total weight of the referenced composition.

The term “fat,” as used herein, refers to lipid components that are solid or in the form of a paste at 20° C., whereas the term “oil” used in the present disclosure refers to lipid components that are liquid at 20° C.

The terms “lipid,” “fat,” and “oil” refer to compounds selected from fatty acid glycerides (monoglycerides, diglycerides, and triglycerides), fatty acids. With reference to lipids, fats, and oils, the term “plant-derived” or “derived from plant sources” means that the carbon atoms in the compound were derived from a plant source. Thus, the term includes compounds generated via hydrogenation or transesterification, so long as the carbon atoms in the compound are derived from one or more plants

The term “emulsion”, as used herein, denotes a mixture of two or more liquids that are normally immiscible (i.e. not mixable). In an emulsion, one liquid (the dispersed phase) is dispersed in the other (the continuous phase). In the present disclosure, it is described an oil-in water emulsions comprising a continuous hydrophilic phase comprising water, in which the hydrophobic phase is dispersed.

“Emulsifiers” are amphiphilic molecules that concentrate at the interface between two phases and modify the properties of that interface. Examples of emulsifiers can be found in McCutcheon's Emulsifiers & Detergents or the Industrial Surfactants Handbook.

The melting profile can be measured by differential scanning calorimeter Q2000 (TA Instruments, New Castle, DE, USA). Typically, small samples (5-10 mg) are sealed in hermetic aluminum pans (Tzero, T161003). Typically, the program consists of the following steps: equilibrate at −20° C. for 5 minutes, ramp to 100° C. at 10° C./min, cooling to −20° C., hold isothermal at −20° C. for 5 min and ramp to 100° C. at 10° C./min. The instrument was calibrated for the melting temperature and enthalpy of fusion of Indium (Standard Reference Material 2232, National Institute of Standards and Technology, Gaithersburg, MD). DSC is widely used to determine percent of fat melted at a certain temperature. This technique is based on measuring the heat of fusion successively at different temperatures. The melting peak temperature and enthalpy of fusion can be obtained using “integrate peak linear” for each DSC curve. The melting peak temperature is the peak temperature of the phase transition curve via DSC. By reference to the total melting heat, the fraction of fat melted is determined. The method is described in “Cassel RB. Determining percent solid in an edible fat. TA Instruments Applications Brief TA290. 2002”. The melting profile is taken from the first heating ramp (scan) of the DSC curve at 10° C./min. The percentage of the solid lipid melted as a function of temperature can be calculated using ‘running integral’. Tₘ represents melting peak temperature, T_{50%} represents the temperature at which 50% by weight of solid lipid melts, T_{95%} represents the temperature at which 95% by weight of solid lipid melts.

In case of combination of more than two components, the melting profile of the mixture can be obtained by the same method as described previously.

By “melting temperature T_{50%}”, it is meant the temperature at which 50% by weight of plant-based fat melts.

By “melting temperature T_{95%}”, it is meant the temperature at which 95% by weight of plant-based fat melts.

Tₘ, T_{50%} and T_{95%} are well-known parameters used by the skilled person in the art. It can be easily determined by DSC (Differential Scanning Calorimetry) as described above.

Other terms are defined in other portions of this description, even though not included in this subsection.

### Gel Compositions

In certain aspects, the disclosure provides a gel composition comprising: (a) water; (b) a lipid component; and (c) a polysaccharide blend.

As noted above, the gel composition comprises water. The gel composition can contain any suitable content of water, so as to form a gel having properties that readily mimic animal fats commonly found in meat products. For example, in some embodiments, the gel comprises water in an amount ranging from 50% by weight to 99% by weight, or from 60% by weight to 90% by weight, or from 65% by weight to 85% by weight, or from 70% by weight to 80% by weight, based on the total weight of the gel composition.

The lipid component includes any suitable fats, oils, or combinations thereof. In some embodiments, the lipid component is an oil, meaning that it is a liquid (as opposed to a solid) at 20° C. Any suitable lipid can be used in the gel composition, including lipids derived from non-animal sources, such as plants, fungi, algae, or any combinations thereof. In some embodiments, the lipid is a plant-derived lipid. In some embodiments, the lipid comprises palm oil, palm kernel oil, coconut oil, fractions of any of the foregoing, an oil derived therefrom, or any combinations thereof. As used herein, the term “fraction” refers to a higher-melting or lower-melting portion of the oil that is separated from the rest of the oil, for example, by crystallization. Palm stearin is a common example of such a fraction, which is obtained by the slow crystallization of palm oil and the separation of the higher-melting portion that crystallizes when heated palm oil is cooled to a temperature near its melting point. Other examples include shea stearin, rice stearin, and the like. In this context, the term “derivative” refers to a synthetic glyceride that is formed by transesterifying the fatty acids of the oil to obtain a higher proportion of glycerides having shorter or longer fatty acid chains. For example, NEOBEE M5 (Stepan Co.) is an example of such a derivative, where coconut and palm kernel oil are transesterified to obtain a composition of triglycerides where the fatty acids are a combination of capric and caprylic acid. In some embodiments, the lipid component comprises a plant-derived oil, which comprises triglycerides of capric acid, caprylic acid, lauric acid, or any combination thereof. For example, in some embodiments, the lipid component comprises at least 50% by weight, or at least 60% by weight, or at least 70% by weight, or at least 80% by weight, or at least 90% by weight, glycerides of capric acid, caprylic acid, lauric acid, or any combination thereof, based on the total weight of glycerides in the lipid component.

In some embodiments, the lipid component comprises a free fatty acid. In some such embodiments, the free fatty acids are derived from non-animal sources, such as plants, fungi, algae, or any combinations thereof. In some embodiments, the non-animal free fatty acids are derived from plants, such as palm, palm kernel, or coconut. Non-limiting examples of free fatty acids suitable for use in the lipid component include capric acid, caprylic acid, lauric acid, myristic acid, palmitic acid, stearic acid, oleic acid, linoleic acid, linolenic acid, eicosapentaenoic acid, docosahexaenoic acid, or any combinations thereof.

The lipid component can make up any suitable proportion of the gel composition. In some embodiments, for example, the concentration of the lipid component in the gel composition ranges from 1% by weight to 50% by weight, or from 5% by weight to 45% by weight, or from 10% by weight to 40% by weight, based on the total weight of the gel composition.

In general, the lipid component is a liquid at room temperature (20° C.). Thus, in some embodiments, the lipid component has a peak melting temperature (Tₘ) of no more than 15° C., or no more than 10° C., or no more than 5° C.

In some embodiments, the lipid component principally contains saturated fats. Thus, in some examples, the lipid component has an iodine value of no more than 0.5, or no more than 0.4, or no more than 0.3, or no more than 0.2, or no more than 0.1.

The polysaccharide blend can comprise any suitable polysaccharide. In some embodiments, the polysaccharide blend comprises a first polysaccharide and a second polysaccharide. In some embodiments, the first polysaccharide is glucomannan. The glucomannan may be present in any suitable form, such as in isolated form or as a component of a natural product, such as a konjac or a product derived from konjac. In some embodiments, the second polysaccharide is not glucomannan. In some instances, such as when glucomannan is the first polysaccharide, the second polysaccharide is present for the purpose of partially disrupting the gel formed by the glucomannan, so as to yield a gel that is less firm and that has rheological properties more akin to those of animal fats found in meat products. In some embodiments, the second polysaccharide is a carrageenan, such as alpha-carrageenan, beta-carrageenan, gamma-carrageenan, delta-carrageenan, theta-carrageenan, iota-carrageenan, kappa-carrageenan, lambda-carrageenan, mu-carrageenan, nu-carrageenan, or any combination thereof. In some embodiments, the carrageenan is kappa-carrageenan. In some other embodiments, the second polysaccharide is a blend of polysaccharides found in seaweed flour. Suitable seaweed flours for such use include WAVEPURE (Cargill, LLC, Wayzata, Minn., USA) or SEAFLOUR (Int'l Flavors & Fragrances, New York, N.Y., USA).

The polysaccharide blend can be present in any suitable concentration in the gel composition. For example, in some embodiments, the gel composition comprises the polysaccharide blend in a concentration ranging from 0.1% by weight to 10% by weight, or from 0.2% by weight to 7% by weight, or from 0.4% by weight to 5% by weight, based on the total weight of the gel composition. In embodiments where the first polysaccharide is glucomannan and the second polysaccharide is a carrageenan, the glucomannan and carrageenan can be present in any suitable relative amounts. In some such embodiments, the weight ratio of glucomannan to carrageenan in the gel composition ranges from 1:25 to 5:1, or from 1:20 to 2:1, or from 1:15 to 2:1.

In some embodiments, the gel composition comprises a non-animal protein. Any suitable non-animal protein can be used, such as proteins derived from a plants, seeds, algae, fungi, and the like. In some instances, it may be desirable to use a non-animal protein that has a relatively high solubility in water. For example, in some embodiments, the non-animal protein is a protein that is at least 50% by weight, or at least 55% by weight, or at least 60% by weight, or at least 65% by weight, or at least 70% by weight, or at least 75% by weight, or at least 80% by weight, soluble in water, based on the total weight of the non-animal protein, when introduced to water at a 10% by weight concentration at neutral pH and 25° C. This allows the protein to act as a kind of emulsifier and assist in the gelling process. The non-animal protein can be a protein concentrate or a protein isolate, which, in some embodiments, can be further processed to eliminate proteins of certain molecular weights or to break down the proteins enzymatically to enhance their solubility in water. The protein can come from any suitable non-animal source, such as plants, fungi, or algae. In some embodiments, the non-animal protein is a plant protein. Non-limiting examples of plant proteins include without limitation rice protein, potato protein, pea protein, soybean protein, wheat protein, mung bean protein, walnut protein, bitter melon protein, and corn protein. In some embodiments, the non-animal protein is potato protein, such as potato protein isolate or potato protein concentrate.

The non-animal protein can be present in any suitable concentration in the gel composition. For example, in some embodiments, the concentration of the non-animal protein ranges from 0.1% by weight to 30% by weight, or from 0.5% by weight to 25% by weight, or from 1% by weight to 20% by weight, based on the total weight of the gel composition.

In some embodiments, the gel composition is an emulsion. In some such embodiments, the emulsion is an oil-in-water emulsion. In some other embodiments, the emulsion is a water-in-oil emulsion. In some embodiments, where the non-animal protein has a high degree of water solubility, the non-animal protein serves as an emulsifier to stabilize, at least in part, the emulsion.

In some embodiments, other emulsifiers (besides the non-animal protein) can be present, such as emulsifiers typically used in emulsified food products. When present, such emulsifiers can be present at any suitable concentration. In some embodiments, the concentration of emulsifier in the gel composition ranges from 0.1% by weight to 35% by weight, or from 0.3% by weight to 20% by weight, or from 0.4% by weight to 15% by weight, or from 0.5% by weight to 10% by weight, or from 0.6% by weight to 8% by weight, of emulsifier, based on the total weight of the gel composition.

In general, such emulsifiers are amphiphilic molecules that concentrate at the interface between two phases and modify the properties of that interface. Suitable non-limiting examples of emulsifiers are described in MCCUTCHEON'S EMULSIFIERS & DETERGENTS OR THE INDUSTRIAL SURFACTANTS HANDBOOK. Some specific non-limiting examples of emulsifiers include lecithins, polyoxyethene, stearates, polysorbate 20, sorbitan derivatives (polysorbate 20, polysorbate 80, polysorbate 40, polysorbate 60, and polysorbate 65), mixed ammonium salts of phosphorylated glycerides, enzymatically hydrolyzed carboxymethyl-cellulose, mono- and diglycerides of fatty acids, esters of mono- and diglycerides of fatty acids (such as acetic acid esters, lactic acid esters, citric acid esters, tartaric acid esters, mono- and diacetyl tartaric acid esters, mixed acetic and tartaric acid esters), succinylated monoglycerides, sucrose esters of fatty acids, sucroglycerides, polyglycerol esters of fatty acids, polyglycerol polyricinoleate, propane-1,2-diol esters of fatty acids, propylene glycol esters of fatty acids, lactylated fatty acid esters of glycerol and propanol, thermally oxidized soya bean oil interacted with mono- and diglycerides of fatty acids, sodium stearoyl lactylate, calcium stearoyl lactylate, stearyl tartrate, stearyl citrate, sodium stearoyl fumarate, calcium stearoyl fumarate, sodium dodecyl sulfate, ethoxylated mono- and di-glycerides, methyl glucoside-coconut oil ester, sorbitan monostearate, sorbitan tristearate, sorbitan monolaurate, sorbitan monooleate, sorbitan monopalmitate, sorbitan trioleate, and combinations thereof.

In some embodiments, the gel composition comprises a fructan, such as inulin. In embodiments, that contain inulin, the inulin can be obtained from any suitable source, including, without limitation, leeks, asparagus, onions, wheat, garlic, chicory, oats, soybeans, and Jerusalem artichokes. In some embodiments, the inulin is derived from chicory. The inulin can have any suitable degree of polymerization (DP). In some embodiments, for example, the inulin has an average degree of polymerization (DP) ranging from 10 to 50, or from 10 to 40, or from 10 to 30. Note that the degree of polymerization (DP), as used herein, refers to a weight-average degree of polymerization.

The gel composition can also include certain other additives, which are commonly included in comestible gels. Gelling agents are an example of ingredients that can also be included in the gel composition. Suitable gelling agents include, without limitation, tragacanth, pectin, starch, glucomannan (konjac), carbomer, sodium alginate, gelatin, cellulose derivatives (such as methylcellulose, carboxymethylcellulose, hydroxypropyl-methylcellulose (HPMC), and the like), and polyvinyl alcohol clays. When one or more of such gelling agents are present, they can be present at any suitable concentration. In some such embodiments, the concentration of gelling agent in the gel composition ranges from 0.1% by weight to 20% by weight, or from 0.5% by weight to 15% by weight, or from 1% by weight to 10% by weight, based on the total weight of the gel composition.

In some embodiments, the gel composition comprises one or more flavoring compounds or other taste or taste-enhancing compounds, such as flavoring compounds that impart a savory taste, such as the flavor of beef, chicken, lamb, turkey, pork, mushroom, fish, shellfish, and the like. Such compounds are described in further detail below. In some embodiments, the gel composition comprises components that enhance or impart an umami taste, that enhance or impart a kokumi taste, or that mask or block a bitter taste.

In certain embodiments, the gel composition is thermoresponsive at a temperature ranging from 0° C. to 160° C. In some embodiments, the gel composition has a peak melting temperature ranging from 40° C. to 120° C.

The gel composition can have any suitable pH. For example, in some embodiments, the pH of the gel composition ranges from 5 to 9, or from 6 to 8. In some embodiments, the gel composition comprises one or more acidifiers to adjust the pH and to improve the shelf stability of the product.

In some embodiments, the gel composition comprises one or more preservatives, one or more antioxidants, and the like to improve the shelf stability of the product.

### Flavoring Compounds

The gel composition described above can contain certain flavoring compounds or be used in conjunction with flavoring compounds.

In some embodiments, the flavoring compounds are flavor oils. The term “flavor oil” means a flavoring ingredient or a mixture of flavoring ingredients, solvents or adjuvants used or the preparation of a flavoring formulation, for example, a particular mixture of ingredients which is intended to be added to an edible composition (including but not limited to a beverage) or chewable product to impart, improve, or modify its organoleptic properties, in particular its flavor or taste. The flavor oil is a liquid at about 20° C. Flavoring ingredient is understood to include a variety of flavor materials of both natural and synthetic origins, including single compounds or mixtures. Many of these flavoring ingredients are listed in reference texts such as S. Arctander, PERFUME AND FLAVOUR CHEMICALS (1969), or its more recent versions, or in other works of similar nature such as FENAROLI'S HANDBOOK OF FLAVOUR INGREDIENTS (1975), or SYNTHETIC FOOD ADJUNCTS (1947). Solvents and adjuvants of current use for the preparation of a flavoring formulation are also well known in the industry. These substances are well known to the person skilled in the art of flavoring and/or aromatizing foods and consumer products.

The flavoring compound may be a taste modifier or a taste compound. Examples of taste compounds are salt, inorganic salts, organic acids, sugars, amino acids and their salts, ribonucleotides, and sources thereof. A “taste modifier” is understood as an active ingredient that operates on a human taste receptors, or provides a sensory characteristic related to mouthfeel (such as body, roundness, or mouth-coating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

In some embodiments, the flavoring oil comprises a beef flavor. In some embodiments, the flavoring oil comprises additional components that enhance or impart an umami taste, that enhance or impart a kokumi taste, or that mask or block a bitter taste.

In some embodiments, the flavoring compound is a metal salt or a metal complex. Such compounds can include any comestible metal salt or complex, such as salts or complexes of calcium, magnesium, sodium, potassium, iron, cobalt, copper, zinc, manganese, molybdenum, and selenium. In some embodiments, the iron compound is an iron salt or an iron complex. In some particular embodiments, the metal compound is a ferrous (Fe²⁺) salt or a ferrous (Fe²⁺) complex. In some embodiments, the metal compound is a a ferrous (Fe²⁺) salt, such as ferrous sulfate, ferrous lactate, ferrous fumarate, ferrous gluconate, ferrous succinate, ferrous chloride, ferrous oxalate, ferrous nitrate, ferrous citrate, ferrous ascorbate, ferric citrate, ferric phosphate, or any combination thereof. In some other embodiments, the metal compound is a ferric (Fe³⁺) salt or a ferric (Fe³⁺) complex, such as ferric pyrophosphate. In some embodiments, the iron compound is ferrous lactate, ferrous sulfate, or any combination thereof.

In some embodiments, the iron compound is a heme-containing protein. As used herein, the term “heme containing protein” includes any polypeptide covalently or noncovalently bound to a heme moiety. In some embodiments, the heme-containing polypeptide is a globin and can include a globin fold, which comprises a series of seven to nine alpha helices. Globin type proteins can be of any class (for example, class I, class II, or class III), and in some embodiments, can transport or store oxygen. For example, a heme-containing protein can be a non-symbiotic type of hemoglobin or a leghemoglobin. A heme-containing polypeptide can be a monomer, such as a single polypeptide chain, or can be a dimer, a trimer, tetramer, and/or higher order oligomer. The lifetime of the oxygenated Fe²⁺ state of a heme-containing protein can be similar to that of myoglobin or can exceed it by 10%, or 20%, or 30%>, or 40%, or 50%, or even 100%, or more under conditions in which the heme-protein-containing consumable is manufactured, stored, handled or prepared for consumption.

Non-limiting examples of heme-containing proteins include an androglobin, a cytoglobin, a globin E, a globin X, a globin Y, a hemoglobin, a myoglobin, an erythrocruorin, a beta hemoglobin, an alpha hemoglobin, a protoglobin, a cyanoglobin, a cytoglobin, a histoglobin, a neuroglobins, a chlorocruorin, a truncated hemoglobin (e.g., HbN or HbO), a truncated 2/2 globin, a hemoglobin 3 (e.g., Glb3), a cytochrome, or a peroxidase.

Heme-containing proteins that can be used in the comestible compositions described herein and can be from mammals (for example, farm animals such as cows, goats, sheep, pigs, ox, or rabbits), birds, plants, algae, fungi (for example, yeast or filamentous fungi), ciliates, or bacteria. For example, a heme-containing protein can be from a mammal such as a farm animal (e.g., a cow, goat, sheep, pig, fish, ox, or rabbit) or a bird such as a turkey or chicken. Heme-containing proteins can be from a plant such as Nicotiana tabacum or Nicotiana sylvestris (tobacco); Zea mays (corn), Arabidopsis thaliana, a legume such as Glycine max (soybean), Cicer arietinum (garbanzo or chick pea), Pisum sativum (pea) varieties such as garden peas or sugar snap peas, Phaseolus vulgaris varieties of common beans such as green beans, black beans, navy beans, northern beans, or pinto beans, Vigna unguiculata varieties (cow peas), Vigna radiata (mung beans), Lupinus albus (lupin), or Medicago sativa (alfalfa); Brassica napus (canola), Triticum sps. (wheat, including wheat berries, and spelt); Gossypium hirsutum (cotton); Oryza sativa (rice); Zizania sps. (wild rice); Helianthus annuus (sunflower); Beta vulgaris (sugarbeet); Pennisetum glaucum (pearl millet); Chenopodium sp. (quinoa); Sesamum sp. (sesame); Linum usitatissimum (flax); or Hordeum vulgare (barley). Heme-containing proteins can be isolated from fungi such as Saccharomyces cerevisiae, Pichia pastoris, Magnaporthe oryzae, Fusarium graminearum, Aspergillus oryzae, Trichoderma reesei, Myceliopthera thermophile, Kluyveramyces lactis, or Fusarium oxysporum. Heme-containing proteins can be isolated from bacteria such as Escherichia coli, Bacillus subtilis, Bacillus licheniformis, Bacillus megaterium, Synechocistis sp., Aquifex aeolicus, Methylacidiphilum infernorum, or thermophilic bacteria such as Thermophilus spp. The sequences and structure of numerous heme-containing proteins are known. See, for example, Reedy, et al, Nucleic Acids Research, 2008, Vol. 36, Database issue D307-D313 and the Heme Protein Database available on the world wide web at http://hemeprotein.info/heme.php.

In some embodiments, a non-symbiotic hemoglobin can be from any plant. In some embodiments, a non-symbiotic hemoglobin can be from a plant selected from the group consisting of soybean, sprouted soybean, alfalfa, golden flax, black bean, black eyed pea, northern bean, tobacco, pea, garbanzo, moong bean, cowpeas, pinto beans, pod peas, quinoa, sesame, sunflower, wheat berries, spelt, barley, wild rice, and rice.

In some embodiments, the heme-containing protein is a leghemoglobin, such as a soy, pea, or cowpea leghemoglobin.

The heme-containing proteins or iron salts can be used at any suitable concentration. Examples are set forth in PCT Publication No. WO 2015/153666, which is incorporated herein by reference.

### Methods of Making

In certain aspects, the disclosure provides a process for making a gel composition of the first aspect, the process comprising: (a) mixing water and the polysaccharide blend to form a polysaccharide composition; (b) optionally, introducing a non-animal protein to the polysaccharide composition to form a protein-polysaccharide composition; and (c) introducing a lipid to the polysaccharide composition or the protein-polysaccharide composition to form a gel composition. In some embodiments, the non-animal protein is a protein that is at least 50% by weight soluble in water, based on the total weight of the non-animal protein, when introduced to water at a 10% by weight concentration at neutral pH and 25° C. In some embodiments, the non-animal protein comprises a plant protein, such as potato protein. In some embodiments, the gel composition is an emulsion, such as an oil-in-water emulsion. In some embodiments, the lipid is an oil, such as an oil derived from plant sources. In some embodiments, the fructan comprises inulin.

### Uses and Comestible Compositions

In certain aspects, the disclosure provides use of a gel composition of any of the foregoing aspects or embodiments thereof to reduce the lipid content of a comestible composition. In a related aspect, the disclosure provides a method of reducing a lipid content of a comestible composition, the method comprising introducing a gel composition of the first aspect to the comestible composition. In some embodiments, the use of the gel composition in a comestible composition reduces the lipid content of the comestible composition by 30% to 80%, or from 40% to 80%, or from 50% to 80%, based on the total weight of lipids in the comestible composition.

In certain aspects, the disclosure provides use of a gel composition of any of the foregoing aspects or embodiments thereof to enhance the perceived fattiness of a comestible composition. In a related aspect, the disclosure provides a method of enhancing the perceived fattiness of a comestible composition, the method comprising introducing a gel composition of the first aspect to the comestible composition.

In certain aspects, the disclosure provides use of a gel composition of any of the foregoing aspects or embodiments thereof to enhance the perceived juiciness of a comestible composition. In a related aspect, the disclosure provides a method of enhancing the perceived juiciness of a comestible composition, the method comprising introducing a gel composition of the first aspect to the comestible composition.

In certain aspects, the disclosure provides use of a gel composition of any of the foregoing aspects or embodiments thereof to enhance the perceived creaminess of a comestible composition. In a related aspect, the disclosure provides a method of enhancing the perceived creaminess of a comestible composition, the method comprising introducing a gel composition of the first aspect to the comestible composition.

In certain aspects, the disclosure provides use of a gel composition of any of the foregoing aspects or embodiments thereof to enhance the mouthfeel of a comestible composition. In a related aspect, the disclosure provides a method of enhancing the mouthfeel of a comestible composition, the method comprising introducing a gel composition of the first aspect to the comestible composition.

In certain aspects, the disclosure provides a comestible composition comprising a gel composition of any of the foregoing aspects or embodiments thereof.

The foregoing uses and methods also refer to such comestible compositions as well. Thus, the ensuing disclosure concerning comestible compositions relates sets forth embodiments of aspects related to comestible compositions, as well as aspects related to uses and methods, where the foregoing gel compositions are used in or incorporated into comestible compositions.

The comestible composition can contain various other ingredients, such as ingredients typically included in vegan meat, seafood, and dairy products.

In some embodiments, the comestible composition comprises another non-animal protein, such as a plant protein, for example, pea protein, hemp protein, or soy protein. In some embodiments, the comestible composition comprises one or more flavors or flavor-modifying compounds, such as meat or fish flavorings, iron compounds, and the like. In some embodiments, the comestible composition comprises one or more fibers, such as plant fibers, for example, pea fiber, citrus fiber, and the like.

For example, in some embodiments, the comestible composition comprises a flavored water-in-oil emulsion according to any of the embodiments set forth in PCT Publication No. WO 2020/260628, which is hereby incorporated by reference.

In some embodiments, the comestible composition comprises encapsulated flavor compositions according to any of the embodiments set forth in PCT Publication No. WO 2021/104846, which is hereby incorporated by reference.

The comestible composition can include certain fibers, such as soluble and insoluble fibers, that can provide structure and texture to the comestible composition. In some embodiments, the comestible composition comprises insoluble fiber. Any suitable insoluble fiber can be used. In some embodiments, the insoluble fiber is a plant-derived fiber. Non-limiting examples include nut fibers, grain fibers, rice fibers, seed fibers, oat fibers, pea fibers, potato fibers, berry fibers, soybean fibers, banana fibers, citrus fibers, apple fibers, and carrot fibers. In some embodiments, the insoluble fiber is pea fiber. In some embodiments, the comestible composition comprises a soluble fiber. As used herein, the term “soluble fiber” refers to polysaccharides characterized as being soluble by using the method of the Association of Official Analytical Chemists (AOAC) and as set forth in Prosky et al., J. ASSOC. OFF. ANAL. CHEM., vol. 70(5), pp. 1017-1023 (1988). Any suitable soluble fibers can be used, including, but not limited to, fruit fiber (such as citrus fiber), grain fibers, psyllium husk fiber, natural soluble fibers and synthetic soluble fibers. Natural fibers include soluble corn fiber, maltodextrin, acacia, and hydrolyzed guar gum. Synthetic soluble fibers include polydextrose, modified food starch, and the like. Non-limiting examples of food-grade sources of soluble fiber include inulin, corn fiber, barley fiber, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potatoes, konjac vegetable fiber (glucomannan), Psyllium fiber from seed husks of planago ovate, Psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose. In some embodiments, the comestible composition comprises insoluble and insoluble fibers. The fiber can make up any suitable proportion of the comestible composition. For example, in some embodiments, the fiber makes up from 5 percent by weight to 50 percent by weight, or from 5 percent by weight to 40 percent by weight, or from 5 percent by weight to 30 percent by weight, or from 5 percent by weight to 20 percent by weight, of the comestible composition, based on the total weight of the comestible composition.

In some embodiments, the comestible composition comprises a non-animal protein, such as a plant protein, an algal protein, or a mycoprotein. In some embodiments, the comestible composition comprises a plant-based protein. Non-limiting examples of plant proteins include pea protein, soy protein, almond protein, cashew protein, canola (rapeseed) protein, chickpea protein, fava protein, sunflower protein, wheat protein, oat protein, and potato protein. The non-animal proteins can make up any suitable proportion of the comestible composition. For example, in some embodiments, the non-animal protein makes up from 5 percent by weight to 50 percent by weight, or from 5 percent by weight to 40 percent by weight, or from 5 percent by weight to 30 percent by weight, or from 5 percent by weight to 20 percent by weight, of the comestible composition, based on the total weight of the comestible composition.

In some embodiments, the comestible composition comprises one or more natural extracts to provide color, flavor, and the like. In some embodiments, the comestible composition comprises beetroot extract. The beetroot extract can be used to provide a red color characteristic of uncooked red meat products.

In some embodiments, the comestible compositions disclosed herein comprise a flavoring. In general, the flavoring improves the taste and flavor of the comestible composition or the resulting flavored product in which the comestible composition is used. Such improvement includes reducing the bitterness of the comestible composition or the resulting flavored product, reducing the perception of astringency of the comestible composition or the resulting flavored product, reducing the perception of green taste notes (such as pea taste) of the comestible composition or the resulting flavored product, reducing the perception of cereal notes of the comestible composition or the resulting flavored product, improving the perception of creaminess of the comestible composition or the resulting flavored product, improving the perception of creaminess of the comestible composition or the resulting flavored product, improving the perception of fattiness of the comestible composition or the resulting flavored product, improving the perception of sweetness of the comestible composition or the resulting flavored product, improving the perception of savory taste (umami or kokumi) of the comestible composition or the resulting flavored product, improving the mouthfeel or mouthcoating of the comestible composition or the resulting flavored product, improving the perception of juiciness of the comestible composition or the resulting flavored product, improving the perception of thickness of the comestible composition or the resulting flavored product, improving the vanillic character of the comestible composition or the resulting flavored product, or any combination thereof.

Any suitable flavoring can be used. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, Eucalyptus oil, thyme oil, cedar leaf oil, oil of nutmeg, allspice, oil of sage, mace, oil of bitter almonds, and Cassia oil. Non-limiting examples of other flavors include natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, Papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an Angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a Sassafras flavor, a savory flavor, a Zanthoxyli Fructus flavor, a Perilla flavor, a juniper berry flavor, a ginger flavor, a star anise flavor, a horseradish flavor, a thyme flavor, a tarragon flavor, a dill flavor, a Capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish creme, white chocolate, raspberry, pumpkin pie spice, peppermint, or any combination thereof.

In some embodiments, the flavoring is a meat flavoring, or other flavorings commonly used in the context of savory products. Such flavorings include glutamates, arginates, avocadene, avocadyne, a purine ribonucleitide (such as inosine monophosphate (IMP), guanosine monophosphate (GMP), hypoxanthine, inosine), a yeast extract, a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, or any combinations thereof.

In some embodiments, the flavoring comprises a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to 10 nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

The flavoring also includes, in certain embodiments, one or more additional flavor-modifying compounds, such as compounds that enhance sweetness (e.g., phloretin, naringenin, glucosylated steviol glycosides, etc.), compounds that block bitterness, compounds that enhance umami, compounds that enhance kokumi, compounds that reduce sourness or licorice taste, compounds that enhance saltiness, compounds that enhance a cooling effect, compounds that enhance mouthfeel, or any combinations of the foregoing.

Thus, in some embodiments, the flavoring comprises one or more sweetness enhancing compounds. Such sweetness enhancing compounds include, but are not limited to, naturally derived compounds, such as hesperitin dihydrochalcone, hesperitin dihydrochalcone-4′-O′ glucoside, neohesperitin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth. In some embodiments of any of the preceding embodiments, the comestible composition comprises 3-((4-amino-2,2-dioxo-1H-benzo[c][1,2,6]thiadiazin-5-yl)oxy)-2,2-dimethyl-N-propyl-propanamide or N-(1-((4-amino-2,2-dioxo-1H-benzo[c][1,2,6]thiadiazin-5-yl)oxy)-2-methyl-propan-2-yl)isonicotinamide.

In some further embodiments, the flavoring comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl)decane-3,5-diol diacetate. In some embodiments, the umami-enhancing compound is N-(heptan-4-yl)benzo[d][1,3]dioxole-5-carboxamide.

In some further embodiments, the flavoring comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, the flavoring comprises one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

In some further embodiments, the flavoring comprises one or more mouthfeel enhancing compounds. Such mouthfeel enhancing compounds include, but are not limited to, tannins, cellulosic materials, bamboo powder, and the like.

In some further embodiments, the flavoring comprises one or more flavor masking compounds. Such flavor masking compounds include, but are not limited to, cellulosic materials, materials extracted from fungus, materials extracted from plants, citric acid, carbonic acid (or carbonates), and the like.

In some embodiments, the flavor-modifying compounds described above are included to improve other tastants that may be present in the comestible composition itself, or that may be included within the flavored products that employ such compositions. Such tastants include sweeteners, umami tastants, kokumi tastants, bitter tastants, sour tastants, and the like.

For example, in some embodiments, the comestible composition or the resulting flavored product comprises a sweetener. The sweetener can be present in any suitable concentration, depending on factors such as the sweetener's potency as a sweetener, its solubility, and the like.

For example, in some embodiments, the sweetener is present in an amount from 0.1 weight percent to 12 weight percent. In some embodiments, the sweetener is present in an amount from 0.2% to 10% by weight. In some embodiments, the sweetener is present in an amount from 0.3% to 8% by weight. In some embodiments, the sweetener is present in an amount from 0.4% to 6% by weight. In some embodiments, the sweetener is present in an amount from 0.5% to 5% by weight. In some embodiments, the sweetener is present in an amount from 1% to 2% by weight. In some embodiments, the sweetener is present in an amount from 0.1% to 5% by weight. In some embodiments, the sweetener is present in an amount from 0.1% to 4% by weight. In some embodiments, the sweetener is present in an amount from 0.1% to 3% by weight. In some embodiments, the sweetener is present in an amount from 0.1% to 2% by weight. In some embodiments, the sweetener is present in an amount from 0.1% to 1% by weight. In some embodiments, the sweetener is present in an amount from 0.1% to 0.5% by weight. In some embodiments, the sweetener is present in an amount from 0.5% to 10% by weight. In some embodiments, the sweetener is present in an amount from 2% to 8% by weight. In some further embodiments of the embodiments set forth in this paragraph, the additional sweetener is sucrose, fructose (such as high-fructose corn syrup, fruit juice, and the like), glucose, xylitol, erythritol, glucose, allulose, or any combinations thereof. In some embodiments, the sweetener is sucrose.

In some other embodiments, the sweetener is present in an amount ranging from 10 ppm to 1000 ppm. In some embodiments, the sweetener is present in an amount from 20 ppm to 800 ppm. In some embodiments, the sweetener is present in an amount from 30 ppm to 600 ppm. In some embodiments, the sweetener is present in an amount from 40 ppm to 500 ppm. In some embodiments, the sweetener is present in an amount from 50 ppm to 400 ppm. In some embodiments, the sweetener is present in an amount from 50 ppm to 300 ppm. In some embodiments, the sweetener is present in an amount from 50 ppm to 200 ppm. In some embodiments, the sweetener is present in an amount from 50 ppm to 150 ppm. In some further embodiments of the embodiments set forth in this paragraph, the additional sweetener is a steviol glycoside (such as rebaudioside A, rebaudioside D, rebaudioside E, rebaudioside M, or any combination thereof), a mogroside (such as mogroside III, mogroside IV, mogroside V, siamenoside I, isomogroside V, mogroside IV_{E}, isomogroside IV, mogroside III_{E}, 11-oxomogroside V, the 1,6-α isomer of siamenoside I, and any combinations thereof), a derivative of either of the foregoing, such as glycoside derivatives (e.g., glucosylates), cyclamate, aspartame, sucralose, acesulfame K, or any combination thereof.

In general, the comestible compositions can include any suitable sweeteners or combination of sweeteners. In some embodiments, the sweetener is a common saccharide sweetener, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the additional sweetener is a combination of two or more of the sweeteners set forth in this paragraph. In some embodiments, the sweetener may combinations of two, three, four or five sweeteners as disclosed herein. In some embodiments, the additional sweetener is a sugar. In some embodiments, the additional sweetener is a combination of one or more sugars and other natural and artificial sweeteners. In some embodiments, the additional sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar is sucrose. In some embodiments, the sugar is a combination of fructose and glucose.

In some embodiments, the sweeteners can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

In some embodiments, the comestible composition comprises an emulsifier, such as a non-hydrocolloid emulsifier. Any suitable non-hydrocolloid emulsifier can be used. For example, in some non-limiting embodiments, the emulsifier comprises lecithin, monoglycerides, diglycerides, polysorbates, vegetable oils, and the like. In some embodiments, the emulsifier comprises lecithin. The emulsifier can be present in any suitable concentration, which can be adjusted so as to form a stable emulsion of the other components in the comestible composition, for example, when incorporated into a flavored product.

In some instances, it may be desirable to include additives that assist in adjusting the viscosity of the comestible composition. Various salts and acids can be used to carry out such adjustments. In some embodiments, the comestible composition or the resulting flavored product comprises one or more salts. Non-limiting examples of suitable salts include magnesium sulfate, sodium chloride, sodium sulfate, calcium chloride, calcium sulfate, potassium sulfate, potassium chloride, potassium sorbate, potassium phosphate, potassium monophosphate, zinc chloride, zinc sulfate, or any mixtures thereof. In some embodiments, the comestible composition or the resulting flavored product also comprises one or more acids, which may be used alone or in combination with the aforementioned salts. Non-limiting examples of suitable acids include citric acid, lactic acid, acetic acid, tartaric acid, succinic acid, ascorbic acid, maleic acid, phosphoric acid, monopotassium phosphate, gluconic acid, glucono-lactone, glucoronic acid, glycyrrhetic acid, folic acid, pantothenic acid, or mixtures thereof.

The comestible compositions disclosed herein can, in certain embodiments, contain other additives, adjuvants, and the like, that are commonly included in food products, pet food products, and feed products. For example, the comestible compositions disclosed herein can, in certain embodiments, comprise any additional ingredients or combination of ingredients as are commonly used in comestible products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, Panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

### Flavored Products

In certain aspects, the disclosure provides a flavored product, which comprises the comestible composition according to any of the embodiments set forth above. The comestible composition can be present in the flavored product in any suitable amount. In some embodiments, for example, the comestible composition makes up from 10 wt % to 99 wt %, or from 20 wt % to 99 wt %, or from 30 wt % to 99 wt %, or from 40 wt % to 99 wt %, or from 50 wt % to 99 wt %, of the flavored product, based on the total weight of the flavored product.

In certain aspects, the disclosure provides flavored products, which comprise the comestible composition according to any of the embodiments set forth above. In some embodiments, the flavored product is a food product, such as a meat analogue product, for example, a non-animal-based ground beef replica. In some other embodiments, the flavored product is an animal feed product, such as pet food product. In such flavored products, the comestible composition can, in some embodiments, be used in combination with animal-based products to reduce the degree of animal fats or animal products in the comestible product. In other embodiments, the flavored products contain no animal-based products, such that the comestible composition is used to make an analogue or a replica of a meat product, such as a ground beef patty.

In some other embodiments, the flavored product is a meat-replacement product (or meat analogue), such as a product designed to mimic products traditionally made from red meat. For example, the flavored product can be a meat dough, such as those described in PCT Publication No. WO 2015/153666. Such flavored products can be designed to simulate beef products, such as ground beef (for making burgers) or cuts of beef for inclusion in soups, prepared meals, and the like. The flavored products can also be designed to simulate cuts or ground forms of other red meat, such as pork, goat, lamb, venison, and bison.

In some embodiments, the flavored product is a seafood analogue product. Certain non-limiting examples of such seafood analogue products include a salmon analogue product, a squid (calamari) analogue product, a shrimp analogue product, a crabmeat analogue product, and the like. In some embodiments, the flavored product is a meat analogue product, such as a poultry analogue product, a pork analogue product, and the like. In some embodiments, the flavored products contain no animal-derived products.

In some embodiments, the flavored product further comprises one or more seafood-derived components, such as juice or extract of seafood, meat of seafood, eggs of seafood, and the like. Such seafood-derived products can come from any suitable seafood source, including, but not limited to, fish (such as pollock, cod, tilapia, salmon, halibut, swordfish, tuna, herring, mackerel, perch, sardines, anchovies, tilefish, trout, mahi-mahi, bass, char, branzino, hake, sea bream, brill, yellowtail, snapper, haddock, turbot, basa, red mullet, walleye, catfish, amberjack, sole, flounder, and the like), crab, clams, mussels, oysters, squid, octopus, cuttlefish, winkles, scallops, sea urchin, sea pineapple, shrimp, crayfish, and lobster. Such seafood-derived products can be present in the flavored product in any suitable amount. In some embodiments, for example, such seafood-derived products make up from 1 wt % to 50 wt %, or from 1 wt % to 40 wt %, or from 1 wt % to 30 wt %, or from 1 wt % to 20 wt %, or from 1 wt % to 10 wt %, of the flavored product, based on the total weight of the flavored product.

Such seafood or meat analogue products can be made by any suitable means. For seafood analogue products, the resulting product would ordinarily have a particular shape and color indicative of the shape and color of the seafood product they are designed to replicate. For example, a calamari analogue product may be formed in the shape of a ring, which is indicative of sliced rings of squid meat. Or a shrimp analogue product may be formed in the shape of a peeled piece of shrimp and may have orange color added to simulate the appearance of cooked shrimp. Or a fish analogue product, such as a salmon analogue, may be formed in the shape of a fillet or steak and may have orange and pink color added to simulate the appearance of an actual salmon fillet or steak.

Such shaping can be carried out by any suitable means. In some embodiments, such seafood analogue products are formed by a molding process, where the ingredients are placed into a mold and the seafood analogue product gels within the mold to form a molded product. In some other embodiments, the seafood analogue products can be formed by an extrusion process, such as a dynamic extrusion process.

### EXAMPLES

To further illustrate this invention, the following examples are included. The examples should not be construed as specifically limiting the invention. Variations of these examples within the scope of the claims are within the purview of one skilled in the art and are considered to fall within the scope of the invention as described, and claimed herein. The reader will recognize that the skilled artisan, armed with the present disclosure, and skill in the art is able to prepare and use the invention without exhaustive examples.

### Example 1: Preparation of Thermoresponsive Gel

Table 1 shows the composition of five (5) different gel formulations. The potato protein isolate derived from potato juice is incorporated with chicory inulin fiber, vegetable oil, and water to obtain a thermoresponsive gel with desirable gel properties. The ratio of potato protein, inulin, vegetable oil, and water determines gel properties. Samples A-D show gel compositions having features of the embodiments disclosed herein, while Sample E is a comparative sample.

TABLE 1

| | Samples | | | | |
|---|---|---|---|---|---|
| | A | B | C | D | E |
| Composition | Weight % | | | | |
| Potato protein isolate | 8.5% | 2% | 15% | 10% | 0 |
| (Solanic 300, Avebe | | | | | |
| Netherlands) | | | | | |
| Inulin (XL, Cargill) | 11.5% | 23% | 0 | 0 | 30% |
| Vegetable oil | 30% | 25% | 0 | 30% | 0 |
| (Neobee M5) | | | | | |
| Water | 50% | 50% | 85% | 60% | 70% |

| | |
|---|---|
| Total | 100% |

To prepare the thermoresponsive gels, potato protein isolate (Solanic 300, Avebe Netherlands) was dissolved completely in deionized water with an IKA overhead stirrer. Chicory root-derived Inulin (XL, Cargill USA) was then mixed with the protein solution thoroughly to ensure the mixture is homogeneous. Vegetable oil (Neobee M5) was added into protein-inulin mixture. The resulting mixture was homogenized using an IKA T18 homogenizer at 12000 rpm for 3 minutes. The obtained emulsion mixture was held in a water bath at 80° C. for 10 minutes followed by cooling in the fridge for overnight to ensure gel formation. In all five cases, a gel was successfully formed.

### Example 2: Physical Characterization—Griddle Test

Cylindrical patties were formed from each of the five (5) gel compositions. Each of the five (5) gels was placed on a flat griddle at 220° C. Each of the five (5) gels responded to the heat of the griddle, and melted to form a liquid.

### Example 3: Physical Characterization—Rheology

Shear oscillatory experiments were performed using an MCR 302 rheometer (Anton Paar, Graz, Austria) with concentric cylinder geometry. Samples (either emulsion mixture or solution depending on the example) were loaded into the cup with temperature controlled by Peltier units. A thin layer of vegetable oil was added on the top of the sample to prevent the water evaporation during the heating. RheoCompass software and firmware (Anton Paar, Graz, Austria) provided the storage modulus (G′), loss modulus (G″), and shear strain (Y) values used for analysis. The gel was formed in-situ in the cup by heating up to 80° C. and then cooling down to 25° C. After that the temperature sweeps were performed, where the temperature was firstly increased from 25° C. to 90° C. at 5° C./min, held at 90° C. for 10 minutes, then decreased to 25° C. at 5° C./min followed by holding at 25° C. for 20 minutes. During the temperature sweep the shear strain was kept constant at 0.005% and the frequency was kept constant at 10 Hz.

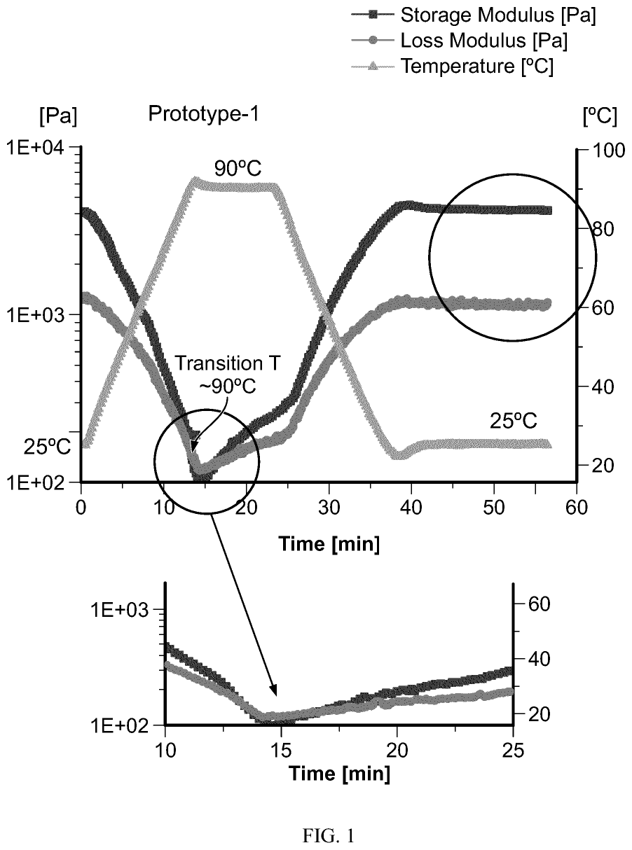

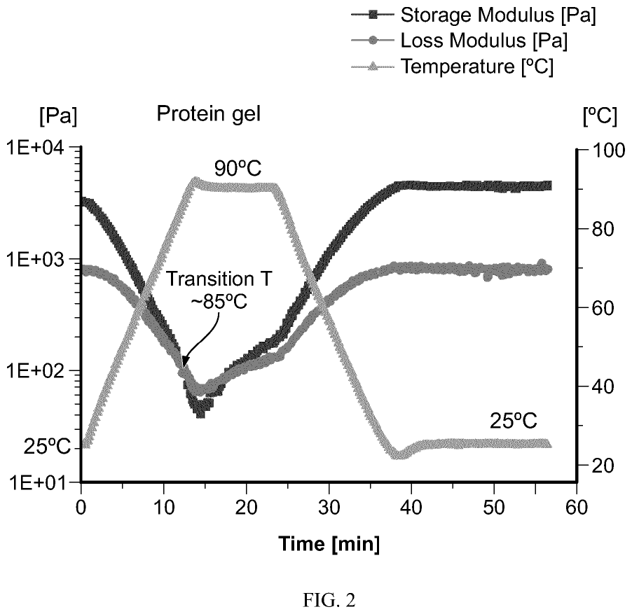

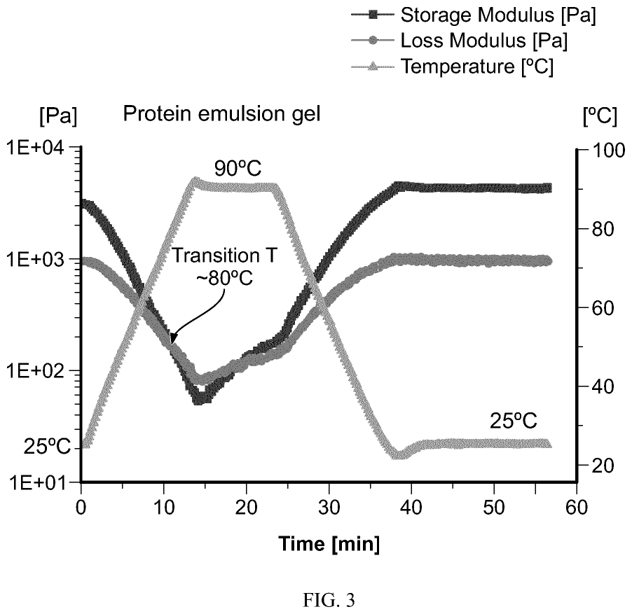

FIG. 1 shows the storage modulus, loss modulus, and temperature for the Sample A gel. As shown in FIG. 1, Sample A had a thermal transition behavior when heated to 90° C.: there was a small region that the loss modulus became higher than the storage modulus indicating that the whole sample behaved more like the flowable liquid and the solid gel sample became liquid after heating. As the temperature was decreased from 90° C. to 25° C., both the storage modulus and loss modulus were recovered to the initial state. This thermal transition behavior was quite similar to those for Sample C and Sample D, which are shown in FIG. 2 and FIG. 3, respectively.

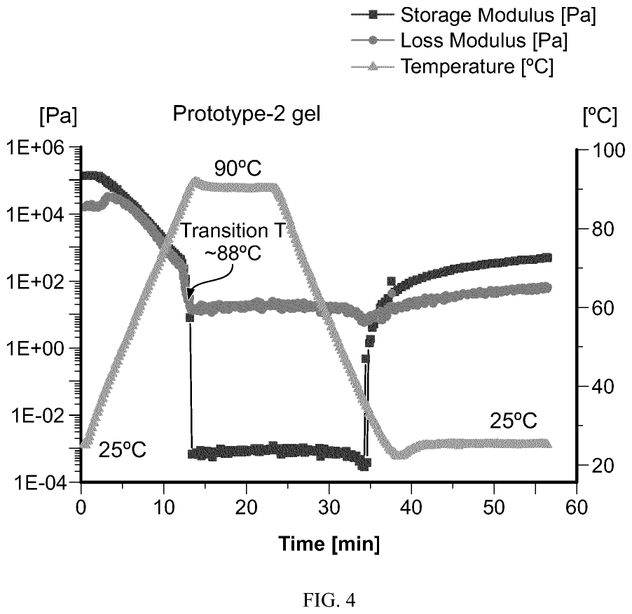

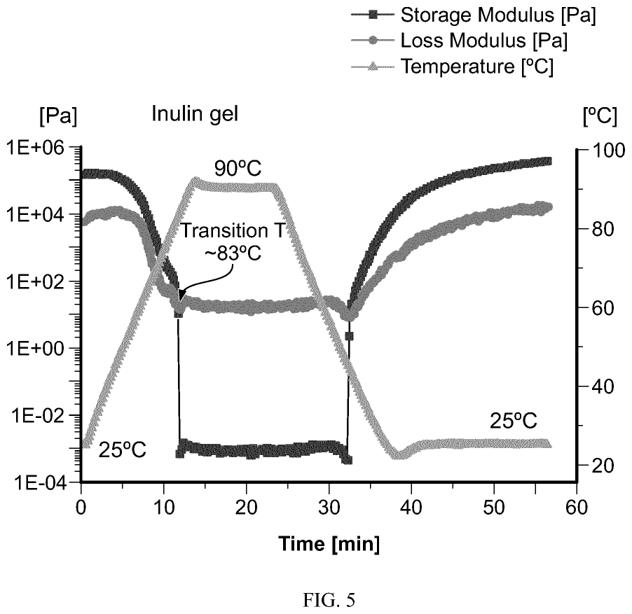

As shown in FIG. 4 and FIG. 5, Sample B and Sample E, respectively, behaved similarly and Sample B was not recovered to initial state as inulin gel after heating and cooling. Both Sample B and Sample E have a thermal transition after heated up where the whole sample changed from solid to liquid. And after the system was cooled down, the sample became solid again except for Sample B, the rheological responses were not recovered to the initial state.

### Example 4—Texture Profile Analysis

A Model TA-HD plus texture analyzer (Stable Micro Systems, Texture Technologies Corp., Hamilton, MA, USA) affixed with a 50 kg load cell was used to perform texture profile analysis on the gel samples. All the gel samples were tested right after removal from the refrigerator storage. A 2% gelatin gel (250 bloom) sample was used as a benchmark for comparison. The sample container was positioned centrally under the probe for the penetration test. At least three gel samples were tested for each example for the mean maximum force. The test protocol was conducted according to “Measurement of firmness of margarine”, provided by the texture analyzer supplier, with minor modifications:
Mode: Measure Force in Compression
Probe: 5 mm diameter cylindrical probe
Test speed: 2.0 mm/s
Pre-test speed: 1.0 mm/s
Post-test speed: 2.0 mm/s
Distance: 12 mm
Trigger type: auto 5 g
Data acquisition rate: 500 pps
   The maximum peak force (g) in the first compression cycle was used as a measure of gel strength. Table 2 sets forth the results for the gelatin standard and each of the five test samples.

TABLE 2

| | Max. Peak Force (g) |
|---|---|
| Gelatin | 41.47 |
| Sample A | 74.80 |
| Sample B | 103.61 |
| Sample C | 37.96 |
| Sample D | 35.62 |
| Sample E | 260.72 |

Sample C and Sample D exhibited similar firmness as the 2% gelatin gel sample. Sample E has the highest firmness.

### Example 5: Preparation of Thermoresponsive Gel

Table 3 shows the composition of six (6) different gel formulations. The potato protein isolate derived from potato juice is incorporated with konjac, carrageenan, vegetable oil, and water to obtain a thermoresponsive gel with desirable gel properties. The ratio of potato protein, konjac, carrageenan, vegetable oil, and water determines gel properties.

TABLE 3

| | Samples | | | | | |
|---|---|---|---|---|---|---|
| | F | G | H | I | J | K |
| Composition | Weight % | | | | | |
| Potato protein | 0.5% | 0.5% | 0.5% | 0.5% | 0.5% | 0.35% |
| isolate (Solanic | | | | | | |
| 300, Avebe | | | | | | |
| Netherlands) | | | | | | |
| Konjac | 0.2% | 0.3% | 0.4% | 0.6% | 0.75% | 0.49% |
| (Ingredion, | | | | | | |
| NJ, USA) | | | | | | |
| Carrageenan | 0.8% | 1.2% | 1.6% | 2.4% | 0.75% | 1.96% |
| (Ingredion, | | | | | | |
| NJ, USA) | | | | | | |
| Vegetable oil | 20% | 20% | 20% | 20% | 20% | — |
| (Neobee M5) | | | | | | |
| Vegetable Oil | — | — | — | — | — | 30% |
| (Rapeseed Oil) | | | | | | |
| Water | 78.5% | 78% | 77.5% | 76.5% | 78% | 67.2% |

| | |
|---|---|
| Total | 100% |

The potato protein isolate (Solanic 300, Avebe Netherlands) was dissolved completely in deionized water with an IKA overhead stirrer. Konjac and kappa-carrageenan were slowly added to the solution with agitation. Then the mixture solution was heated to 80-85° C. with agitation for 15 minutes to ensure the mixture is homogeneous and fully hydrated. Vegetable oil was added into the solution. The whole mixture was homogenized using an IKA T18 homogenizer at 12000 rpm for 3 minutes. The obtained emulsion mixture was cooled at room temperature and stored in refrigerator for analysis and ground for use.

### Example 6—Physical Characterization—Rheology

Shear oscillatory experiments were performed using a MCR 302 rheometer (Anton Paar, Graz, Austria) with concentric cylinder geometry. Emulsion gel prototypes were loaded into the cup with temperature controlled by Peltier units. A thin layer of vegetable oil was added on the top of the sample to prevent the water evaporation during the heating. RheoCompass software and firmware (Anton Paar, Graz, Austria) provided the storage modulus (G′), loss modulus (G″), and shear strain (Y) values used for analysis. Temperature sweeps were performed, where the temperature was firstly increased from 20° C. to 80° C. at 5° C./min, held at 80° C. for 10 minutes, then decreased to 20° C. at 5° C./min followed by holding at 20° C. for 20 minutes. During the temperature sweep the shear strain was kept constant at 0.005% and the frequency was kept constant at 10 Hz. The temperatures at which G′ equals to G″ were recorded for both heating and cooling processes. When G′ is larger than G″, the sample behaves more like a solid; whereas when G′ is smaller than G″, the sample behaves more like a fluid.

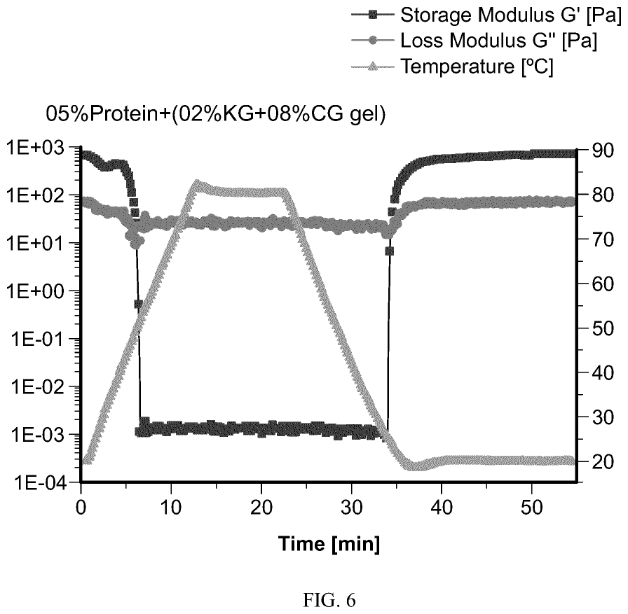

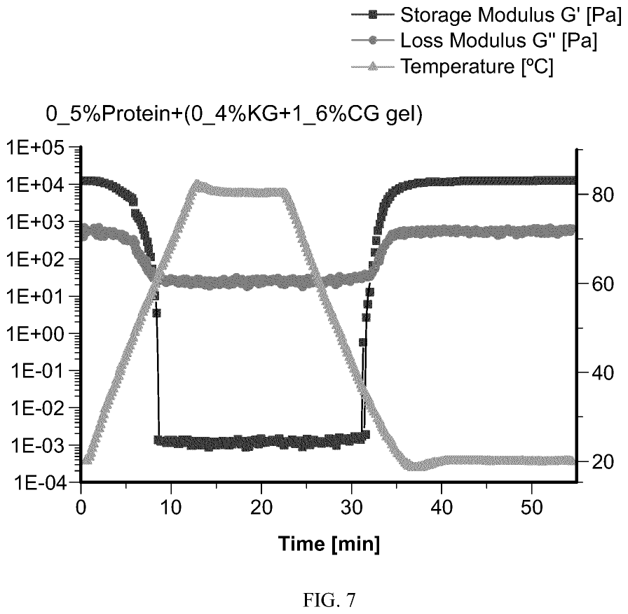

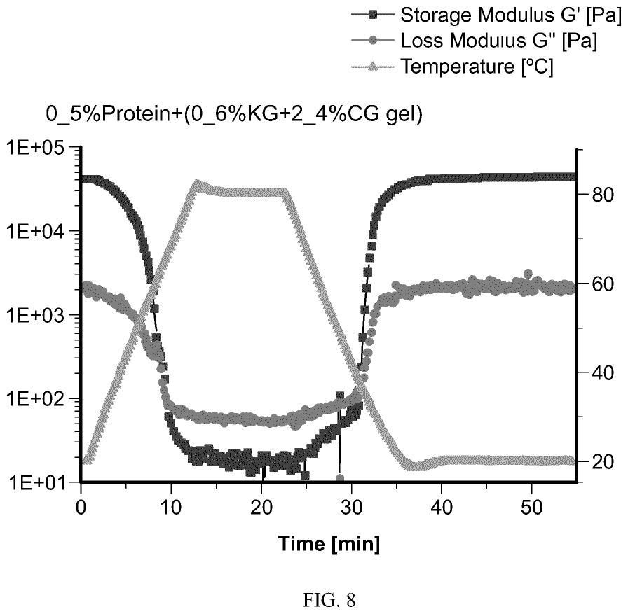

FIGS. 6-8 show the rheology measurements for Sample F, Sample H, and Sample I, respectively. All gel prototypes showed thermal transition when heated up from 20° C. to 80° C. and cooled from 80° C. to 20° C. With the increase in concentration of konjac and carrageenan, the thermal transition temperatures during both heating and cooling processes increased. This suggest that both melting and gelling temperatures are tunable.

### Example 7—DSC Characterization

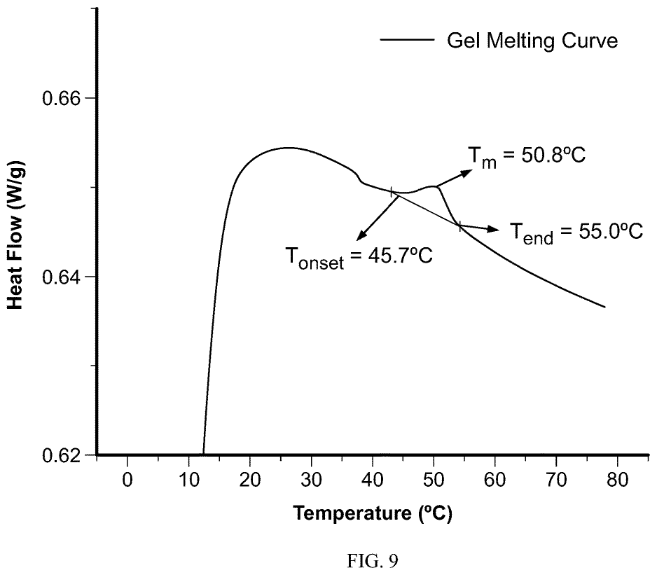

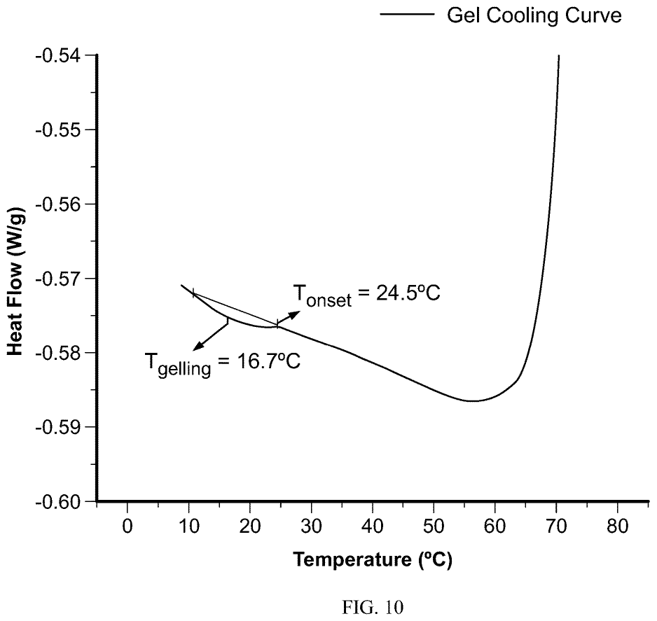

Gel prototypes were also characterized by differential scanning calorimetry Q2000 (TA Instruments, New Castle, DE, USA). Small samples (10-20 mg) were sealed in hermetic aluminum pans (Tzero, T161003). The program included the following steps: equilibrate at 5° C. for 5 minutes, ramp to 80° C. at 10° C./min, and cooling to 5° C. at 10° C./min. The instrument was calibrated for the melting temperature and enthalpy of fusion of Indium (Standard Reference Material 2232, National Institute of Standards and Technology, Gaithersburg, MD). The melting and gelling peak temperatures was taken from the heating cycle and cooling cycle, respectively. All samples were measured in duplicate and an average was reported. FIGS. 9 and 10 show the peak temperatures during heating and cooling processes, respectively, for the gel composition of Sample F.

Thermal transition temperatures during heating and cooling processes were analyzed by rheometer and DSC, respectively. The data were summarized in Table 4. There is a clear trend that both melting and gelling temperatures increased as the concentration of konjac and carrageenan increased. For melting peak temperatures, the data from rheometer agreed well with that from DSC. These data confirmed that these gel prototypes are thermoreversible and the transition temperatures are tunable to meet application requirements.

TABLE 4

| | | | Melting peak | Gelling peak |
|---|---|---|---|---|
| | | | temperature | temperature |
| | Temperature at G′ = G″ (° C.) | | (° C.) | (° C.) |
| | Heating | Cooling | Heating | Cooling |
| Samples | cycle | cycle | cycle | cycle |
| F | 50.1 | 24.4 | 50.4 | 22.8 |
| G | 55.3 | 28.5 | 54.7 | 21.2 |
| H | 59.2 | 32.7 | 60.1 | 24.3 |
| I | 67.3 | 38.4 | 64.8 | 29.8 |
| J | 50.7 | 28.2 | 51.8 | 19.0 |

### Example 8—Preparation in Vegan Patties—Pea Protein

Vegan patties were prepared according to the formulations set forth in Table 5.

TABLE 5

| | Sample L | Sample M | Sample N | Sample O |
|---|---|---|---|---|
| | (% w/w) | (% w/w) | (% w/w) | (% w/w) |
| Water | 59.9 | 59.9 | 59.9 | 59.9 |
| Pea Protein¹ | 20 | 20 | 20 | 20 |
| Pea Protein² | 1.5 | 1.5 | 1.5 | 1.5 |
| Coconut flakes | 10 | 5 | 2 | 0 |
| Gel (Sample H) | | 5 | 8 | 10 |
| Canola Oil | 5.0 | 5.0 | 5.0 | 5.0 |
| Methylcellulose | 2.0 | 2.0 | 2.0 | 2.0 |
| Salt (NaCl) | 0.8 | 0.8 | 0.8 | 0.8 |
| Lactic Acid | 0.3 | 0.3 | 0.3 | 0.3 |
| Red Beet Color³ | 0.3 | 0.3 | 0.3 | 0.3 |
| Brown Color⁴ | 0.1 | 0.1 | 0.1 | 0.1 |
| Red Color⁵ | 0.1 | 0.1 | 0.1 | 0.1 |

¹The pea protein is Nutralys T70S (Roquette)
²The pea protein is Nutralys F85M (Roquette)
³Redbeet Red WSP (FruitMax)
⁴Brown 700 WSP (FruitMax)
⁵Red 101 WSP (FruitMax)

The vegan patties are made my mixing all ingredients together with a mixer with a paddle attachment for about 2 minutes. Patties were then formed by taking about 100 grams of the mixed material and flattening the material to have a patty-like shape. The patties were then subjected to individual quick freezing (IQF) for 30 minutes and are store in a freezer. The patties were placed in a refrigerator for 24 hours before cooking evaluation. Gel prototypes were ground into smaller pieces with a kitchen grinder before incorporating into patties. The small gel particulates mimic fat marbling which may be visually desirable.

All patties were cooked on an electric griddle. They were cooked for 4 minutes on one side, then flipped and cooked until the inner center temperature reached 65° C. Patty with 10% coconut flakes served as a control. Both coconut flakes and gel particulates were uniformly distributed in the patty base visually mimicking fat marbling. After cooking, coconut flakes and gel particulates were fully melted both on the surface and inside the burger.

Cooking loss was calculated by weighing the difference of cooked burger and raw patty. Sample O has significantly less cooking loss compared to other prototypes. Both Samples L and M showed sizzling and dripping fat on the griddle. Sample O showed no sizzling and little fat residue on the griddle. All these results suggest that partial replacement of vegetable fats with the thermoresponsive gel disclosed herein in vegan patties is possible without compromising the cooking properties. Results are shown in Table 6.

TABLE 6

| Samples | L | M | N | O |
|---|---|---|---|---|
| Cooking loss | 24.0% | 23.4% | 23.6% | 18.9% |
| (% w/w) | | | | |
| Sizzling | Yes | Yes | No | No |
| Dripping fat | Yes | Yes | Little | Little |
| on griddle | | | | |

### Example 9—Preparation in Vegan Patties—Soy Protein

Vegan patties were prepared according to the formulations set forth in Table 7.

TABLE 7

| | Sample P | Sample Q |
|---|---|---|
| | (% w/w) | (% w/w) |
| Water | 59.5 | 59.5 |
| Soy Protein¹ | 10.0 | 10.0 |
| Soy Protein² | 5.0 | 5.0 |
| Soy Protein⁷ | 1.0 | 1.0 |
| Soy Protein⁸ | 5.0 | 5.0 |
| Coconut flakes | 10.0 | 5.0 |
| Gel (Sample K) | — | 5.0 |
| Rapeseed Oil | 5.0 | 5.0 |
| Methylcellulose⁶ | 2.0 | 2.0 |
| Wheat Gluten | 0.5 | 0.5 |
| Salt (NaCl) | 0.8 | 0.8 |
| Fiber Blend | 0.5 | 0.5 |
| Beef Flavoring | 0.2 | 0.2 |
| Red Beet Color³ | 0.3 | 0.3 |
| Brown Color⁴ | 0.1 | 0.1 |
| Red Color⁵ | 0.1 | 0.1 |

¹Response 4310 (DuPont)
²Response 4438 (DuPont)
³Redbeet Red WSP (FruitMax)
⁴Brown 700 WSP (FruitMax)
⁵Red 101 WSP (FruitMax)
⁶Methocell Bind 250 (DuPont)
⁷Supro EX-33 (DuPont)
⁸Texturized Soy Protein (Firmenich)

The vegan patties are prepared by a process similar to that described in Example 8 for the pea-based vegan patties.

### Example 10—Sensory Testing

Sensory evaluation was conducted with 7 trained panelists. Each attribute was rated in a scale of from 0 to 10 representing low to high intensity. The results are shown in Table 8.

TABLE 8

| Rating of Attributes | | |
|---|---|---|
| (0-10 scale) | P | Q |
| Overall soy intensity | 1 | 0.8 |
| Overall beef intensity | 5.1 | 5.9 |
| Overall fat intensity | 4.1 | 4.5 |
| Fat lingering | 3.9 | 4.4 |
| Mouthfeel coating intensity | 4.7 | 4.8 |
| Hardness intensity | 4.1 | 4.7 |
| Chewiness intensity | 3.9 | 4.4 |
| Stickiness intensity | 3.1 | 3.1 |
| Crumbly intensity | 4.7 | 4.1 |
| Overall Liking | 5.2 | 5.9 |

Note that the vegan burger containing the gel-based fat mimetic scored comparably or better that the full fat vegan burger on nearly every index.

### Example 11—Gel Using Seaweed Flour

The gel samples were made following the same procedures as described in Example 5. Table 9 shows the quantities of ingredients in these samples.

TABLE 9

| Ingredients | R | S | T |
|---|---|---|---|
| Potato Protein (Solanic 300) | — | — | 0.4% |
| Konjac (Ingredion) | — | — | 0.8% |
| Seaweed flour (WavePure, Cargill) | 0.8% | 2.4% | 2.4% |
| Water | 79.2% | 77.6% | 76.4% |
| Canola oil | 20% | 20% | 20% |
| Total | 100% | 100% | 100% |

### Example 12—Characterization

Shear oscillatory experiments were performed using a MCR 302 rheometer (Anton Paar, Graz, Austria) with concentric cylinder geometry. Emulsion gel prototypes were loaded into the cup with temperature controlled by Peltier units. A thin layer of vegetable oil was added on the top of the sample to prevent the water evaporation during the heating. RheoCompass software and firmware (Anton Paar, Graz, Austria) provided the storage modulus (G′), loss modulus (G″), and shear strain (Y) values used for analysis. Temperature sweeps were performed, where the temperature was firstly increased from 20° C. to 90° C. at 5° C./min, held at 90° C. for 10 minutes, then decreased to 20° C. at 5° C./min followed by holding at 20° C. for 20 minutes. During the temperature sweep the shear strain was kept constant at 0.005% and the frequency was kept constant at 10 Hz. The temperatures at which G′ equals to G″ were recorded for both heating and cooling processes. When G′ is larger than G″, the sample behaves more like a solid; whereas when G′ is smaller than G″, the sample behaves more like a fluid.

The melting and gelling temperatures are summarized in Table 10. Gels containing seaweed flour showed much higher melting temperature compared to those made with konjac and carrageenan. Gels made with seaweed flour alone are much less elastic compared to gels made of konjac and carrageenan. However, adding konjac to seaweed flour gel increased gel elasticity and grinding performance.

TABLE 10

| Properties | R | S | T |
|---|---|---|---|
| Melting point (G′ = G″ heating cycle) | 74° C. | 82° C. | 86° C. |
| Gelling point (G′ = G″ Cooling cycle) | 29° C. | 38° C. | 38° C. |
| Gel characteristics | soft | firm, not | firm, |
| | | elastic | slightly |
| | | | elastic |

1. A gel composition comprising:
(a) water;
(b) a lipid component; and
(c) a polysaccharide blend, which comprises a first polysaccharide and a second polysaccharide.

2. The gel composition of claim 1, further comprising a non-animal protein.

3. The gel composition of claim 2, wherein the non-animal protein is a protein that is at least 50% by weight soluble in water, when introduced to water at a 10% by weight concentration at neutral pH and 25° C.

4. The gel composition of claim 2 or 3, wherein the non-animal protein comprises potato protein isolate or potato protein concentrate.

5. The gel composition of any one of claims 1 to 4, wherein the gel composition is an emulsion.

6. The gel composition of claim 5, wherein the gel composition is a microemulsion.

7. The gel composition of claim 5 or 6, wherein the emulsion is an oil-in-water emulsion.

8. The gel composition of any one of claims 1 to 3, wherein the lipid component is a plant oil, an algal oil, or a combination thereof.

9. The gel composition of claim 8, wherein the lipid component is a plant oil.

10. The gel composition of any one of claims 1 to 9, wherein the first polysaccharide is glucomannan.

11. The gel composition of any one of claims 1 to 10, wherein the second polysaccharide is an anionic polysaccharide, such as a carrageenan.

12. Use of a gel composition of any one of claims 1 to 11 to reduce the lipid content of a comestible composition.

13. Use of a gel composition of any one of claims 1 to 11 to enhance the perceived fattiness of a comestible composition.

14. Use of a gel composition of any one of claims 1 to 11 to enhance the perceived juiciness of a comestible composition.

15. Use of a gel composition of any one of claims 1 to 11 to enhance the perceived creaminess of a comestible composition.

16. Use of a gel composition of any one of claims 1 to 11 to enhance the mouthfeel of a comestible composition.

17. A comestible composition comprising a gel composition of any one of claims 1 to 11.

18. The comestible composition of claim 17, which further comprises a further plant protein, for example, pea protein, hemp protein, soy protein, or any combination thereof.

19. A flavored product, which comprises a comestible composition of claim 17 or 18.

20. A method of reducing a lipid content of a comestible composition, the method comprising introducing a gel composition of any one of claims 1 to 11 to the comestible composition.

21. A method of enhancing a perceived fattiness of a comestible composition, the method comprising introducing a gel composition of any one of claims 1 to 11 to the comestible composition.

22. A method of enhancing a perceived juiciness of a comestible composition, the method comprising introducing a gel composition of any one of claims 1 to 11 to the comestible composition.

23. A method of enhancing a perceived creaminess of a comestible composition, the method comprising introducing a gel composition of any one of claims 1 to 11 to the comestible composition.
